(19) United States
(12) Patent Application Publication
(10) Pub. No.: US 2008/0265599 A1
(43) Pub. Date: Oct. 30, 2008

(54) MOTOR VEHICLE TRIM ASSEMBLY, METHOD FOR FITTING A TRIM ASSEMBLY OF THIS TYPE AND A MOTOR VEHICLE ASSEMBLY WITH A TRIM ASSEMBLY OF THIS TYPE

(75) Inventors: Thomas Mett, Dohlau (DE); Claus-Christian Steeg, Oelsnitz (DE); Stefan Lux, Dohlau (DE); Wassilios Kiriakou, Gemmrigheim (DE); Jochen Haas, Freiberg (DE); Tihomir Caric, Boblingen (DE)

Correspondence Address: BROWDY AND NEIMARK, P.L.L.C.;624 NINTH STREET, NW, SUITE 300, WASHINGTON, DC, 20001-5303, US

(73) Assignees: REHAU AG + CO., Rehau (DE); Richard Fritz GmbH + Co. KG, Besigheim (DE)

(21) Appl. No.: 12/110,530

(22) Filed: Apr. 28, 2008

(30) Foreign Application Priority Data
Apr. 28, 2007 (DE) 10 2007 020 189.5

(51) Int. Cl. B60R 13/02

(52) U.S. Cl. 296/1.08

(57) ABSTRACT

A motor vehicle trim assembly has a holding body with a receiving groove. The holding body can be fixed in a material-uniting manner to a motor vehicle rear window in an upper window edge region facing the vehicle interior or on a trim part in an upper trim part edge region facing the vehicle interior by means of an adhesion promoter layer. A trim part of the trim assembly is inserted with a rear window-side rim region or the motor vehicle rear window is inserted with a trim-side rim region into the receiving groove. A trim assembly of this type and a motor vehicle assembly also comprising the rear window avoids the visual impression of the visible side of the motor vehicle being limited by visible fastening elements for the trim part.

### BACKGROUND OF THE INVENTION

1. Field of the Invention

The invention relates to a motor vehicle trim assembly with a trim part, which is to be arranged above a rear window of the motor vehicle. The invention also relates to a fitting method for a trim assembly of this type. Furthermore, the invention relates to a motor vehicle assembly with a motor vehicle trim assembly of this type and a rear window.

2. Background Art

An example of a trim part of this type is a rear spoiler or a rear styling conversion kit. It is known from public prior use to fasten trim parts of this type to the tailgate by clipping, screwing or adhesion. For this purpose, fastening points which have to be connected directly to the visible side of the tailgate are required in components of the tailgate. This often leads to a visual impairment.

### SUMMARY OF THE INVENTION

It is therefore an object of the present invention to develop a trim assembly in such a way that a limitation of the visual impression of the visible side of the motor vehicle due to visible fastening elements for the trim part is avoided.

This object is achieved according to the invention by a trim assembly with a holding body having a receiving groove, with a trim part as part of a motor vehicle body, wherein the holding body can be fastened in a material-uniting manner on a motor vehicle rear window in an upper window edge region facing the vehicle interior or on the trim part in ail upper trim part edge region facing the vehicle interior, wherein the trim part is inserted with a rear window-side rim region or the motor vehicle rear window is inserted with a trim-side rim region into the receiving groove.

Visible fastening elements for the rear window-side fastening of the trim part are avoided by the holding body which can be fixed directly to the rear window or directly to the trim part. This direct fixation is done in a material-uniting manner, i.e. via a substance-to-substance bond.

Screwing of the trim part to the body in the region of a tailgate is dispensed with, in particular, as a result. The holding body can also compensate a thermal expansion of the trim part relative to adjacent elements. As the rear window-side connection of the trim part or the trim-side connection of the rear window takes place by means of insertion, the outlay during fitting of the trim assembly is reduced. A subsequent joining process of the rear window-side trim part to a carrier part of the motor vehicle, in other words to a body element, is also dispensed with. The trim part is part of the motor vehicle body, in other words part of the vehicle bodywork. If the trim part is inserted with the rear window-side rim region into the receiving groove, this takes place, in particular, in such a way that the trim part engages behind the motor vehicle rear window in the rear window-side rim region. In this case, no fastening elements are visible on the rear window and this can lead to an improvement in the visual impression of the motor vehicle.

A holding body molded onto the rear window or onto the trim part leads to a clean and reliable fixing of the holding body on the rear window or the trim part in a material-uniting manner.

A contact wall of the holding body for resting on a rear window-side body element of the motor vehicle ensures a defined abutment of the holding body on the body element of the motor vehicle.

A screw connection for connecting the trim part to a roof-side body element, the trim part and/or the body element having a stop for the defined positioning of the trim part with respect to the roof-side body element, in particular allows simple disassembly of the trim part.

Materials for the holding body such as a thermoplastic elastomer (TPE) or a polyurethane (PU) with a Shore hardness of 30 to 65 A have proven to be particularly suitable for providing a secure and tight connection of the trim part to the rear window.

Extending longitudinally in the receiving groove for resting on the trim part and/or on the rear window, sealing lips of the holding body improve the sealing and secure connection of the trim part to the holding body or to the rear window.

A two-part holding body structure comprising a first holding body part that is connected in a material-uniting manner to the motor vehicle rear window or the trim part, and a second holding body part which, with the first holding body part, limits the receiving groove and is positively connected to the first holding body part simplifies the production of the holding body. The individual holding body parts can be produced with less outlay. The second holding body part can be prefabricated, in particular, as an extrudate.

A further object of the invention is to disclose a method for fitting a trim assembly with a trim part at the transition between a rear window and a roof region of a motor vehicle.

This object is achieved according to the invention by a method for fitting a trim assembly on a motor vehicle, the trim assembly having a holding body with a receiving groove and a trim part as part of a motor vehicle body, wherein the holding body can be fastened in a material-uniting manner on a motor vehicle rear window in an upper window edge region facing the vehicle interior or on the trim part in an upper tim part edge region facing the vehicle interior, wherein the trim part is inserted with a rear window-side rim region or the motor vehicle rear window is inserted with a trim-side rim region into the receiving groove, the method comprising the following steps:
fastening the holding body on the rear window or on the trim part;
connecting the rear window to a rear window-side body element of the motor vehicle;
inserting the trim part or the rear window into the receiving groove of the holding body;
pivoting the trim part about a pivot axis extending along the receiving groove until the trim part abuts a roof-side portion of the body element;
connecting a roof-side portion of the trim part to the roof-side portion of the body element.

A method of this type can be prepared in such a way that no additional fastening means are required. This method is therefore particularly well suited for conveyor belt production or mass production.

The advantages of the developments of the method, wherein the holding body is fastened to the rear window or to the trim part by molding the holding body on the rear window or on the trim part; wherein the rear window is connected to the body element by adhesion; wherein the roof-side portion of the trim part is connected to the roof-side portion of the body element by adhesion; wherein the roof-side portion of the trim part is connected to the roof-side portion of the body element by screwing; and wherein before joining the rear window and trim part, the second holding body part is joined to the first holding body part correspond to those which have already been discussed above with reference to the trim assembly.

A rear window connected to the body element by adhesion ensures a clean introduction of forces which act on the trim part and the rear window, to the body element.

Adhesion of a roof-side portion of the trim part to the roof-side portion of the body element allows particularly simple fitting of the trim part.

Connecting the roof-side portion of the trim part to the roof-side portion of the body element by screwing facilitates the disassembly thereof.

Joining the second holding body part to the first holding body part before joining the rear window and trim part is preferably done by snap-in locking.

The advantages of a motor vehicle assembly according to the invention and a rear window connected thereto correspond to those which were discussed above with reference to the trim assembly and the fitting thereof.

Embodiments of the invention will be described in more detail below with the aid of the drawings.

### BRIEF DESCRIPTION OF THE DRAWINGS

FIG. 1 schematically shows a perspective view, partly in an exploded view, of a motor vehicle tailgate with a rear window and a motor vehicle trim part;

FIG. 2 shows a cross-section of the tailgate, in sections and enlarged, along the line II-II in FIG. 1;

FIG. 3 shows an enlargement of a section from FIG. 2;

FIG. 4 shows a cross-section of a modified connection location between the tailgate and trim part shown section-wise corresponding to FIG. 2; and

FIGS. 5 to 7 show views similar to FIG. 2 of further embodiments of motor vehicle trim assemblies.

### DESCRIPTION OF THE PREFERRED EMBODIMENTS

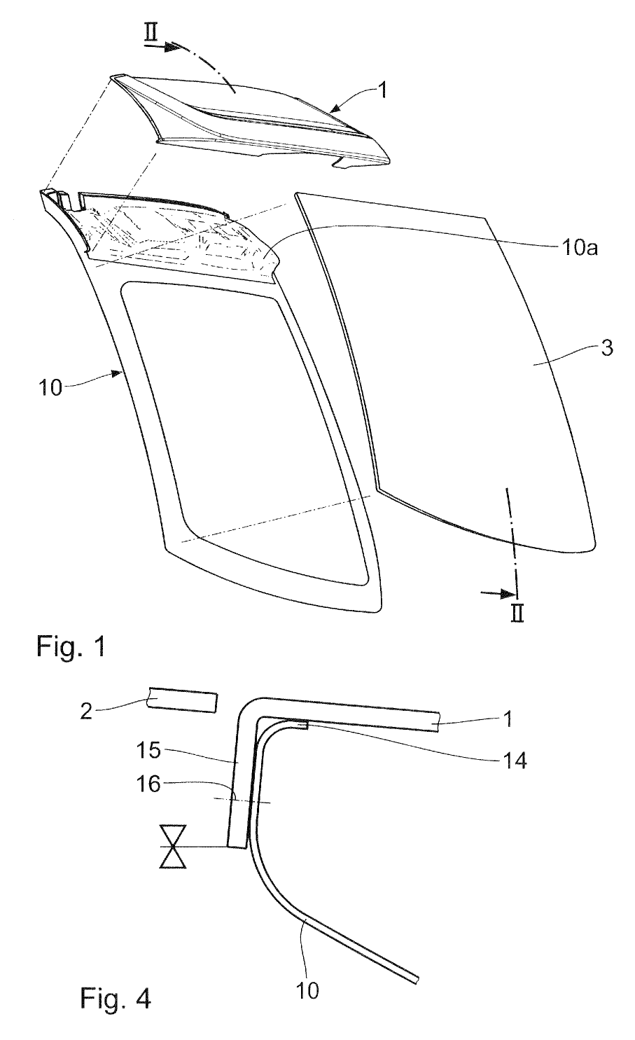

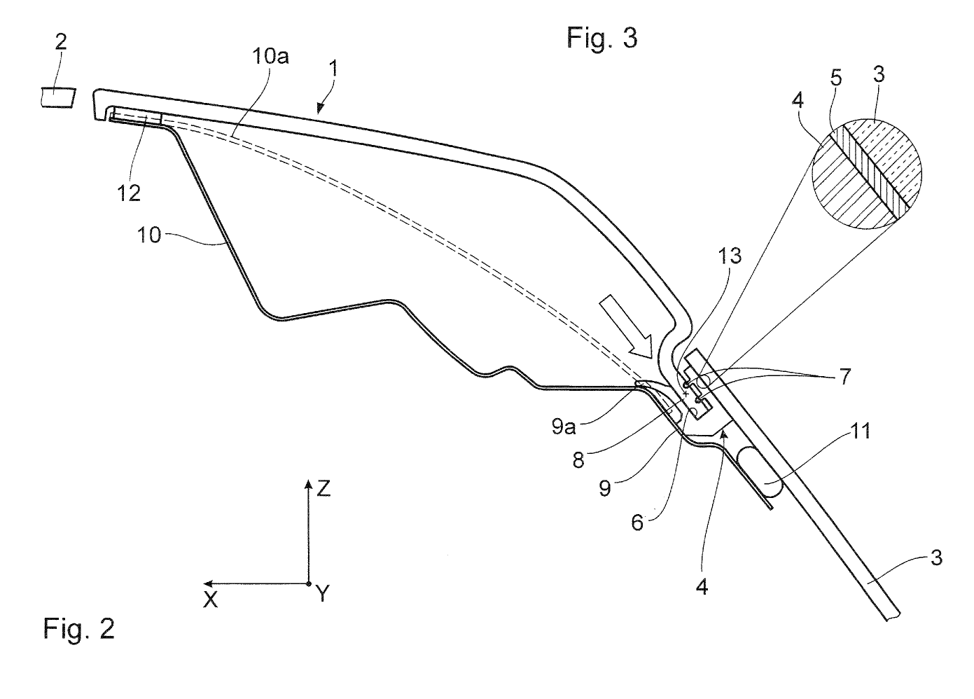

FIG. 1 shows a trim part 1 of a motor vehicle using the example of a rear styling conversion kit as part of a motor vehicle tailgate. The trim part 1 is a component of a motor vehicle trim assembly shown in the cross-section of FIG. 2. The trim part 1 is part of a motor vehicle body. The trim part 1 is made of plastics material. The motor vehicle in this case has a shape in which a roof region 2 passes at the rear into a rear window 3, without a saloon car step following here. Examples of motor vehicle shapes of this type are an SUV, an estate car, a van or a compact vehicle. The trim part 1 ensures a streamlined transition between the roof region 2 and the rear window 3. This is illustrated in the sectional view according to FIG. 2. The section according to FIG. 2 is guided in an XZ-plane of a Cartesian XYZ coordinate system, X being the direction of travel and Z the normal onto a road.

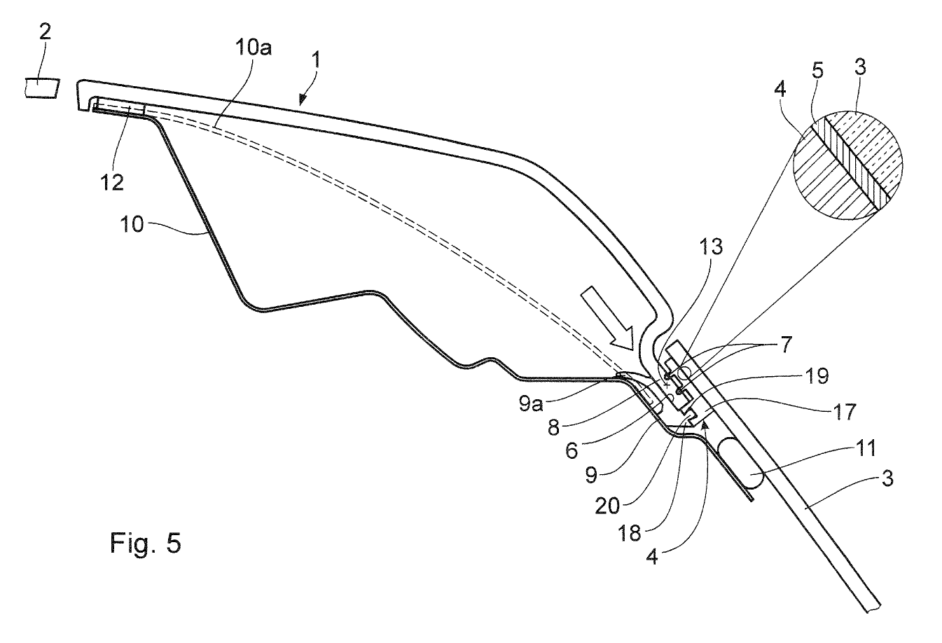

A holding body 4 is molded onto the rear window 3. As the sectional enlargement according to FIG. 3 shows, the holding body 4 rests via an adhesion promoter layer 5 on an inner upper window edge region of the rear window 3 and is fixed thereto in a material-uniting manner by means of the adhesion promoter layer 5. The holding body 4 is made of a thermoplastic elastomer (TPE) or of a polyurethane (PU) with a Shore hardness of between 30 and 65 A.

Parallel to the upper window edge region, the holding body 4 has a receiving groove 6 opening to the tipper top left in FIG. 2. The latter, when the trim assembly is fitted, is completely covered by the upper window edge region of the rear window 3. The receiving groove 6 has two sealing lips 7 which run along the receiving groove 6 and which are shown in FIG. 2 in a relaxed, non-compressed position. A rear window-side rim region 8 of the trim part 1 is inserted into the receiving groove 6.

The holding body 4 rests on a rear window-side body element 10, for example the inner panel of a tailgate (cf. FIG. 1) via a contact wall 9 facing the interior of the motor vehicle. Of this tailgate inner panel 10, a portion is shown in FIG. 2 which is also designated below a body element 10. The contact wall 9 is adjacent to a groove base of the receiving groove 6, so pressure exerted on the contact wall 9 does not lead to practically any deformation of the receiving groove 6. A sealing lip 9a seals the holding body 4 against the body element 10. The rear window 3 is glued below the holding body 4 to the body element 10 by means of an adhesive bead 11. The trim part 1 is glued to a roof-side portion of the body element 10 by means of an adhesive strip acting on both sides.

The body element 10 may also be multi-layered. A second layer 10a of a two-layer body element of this type is shown by dashed lines in FIG. 2. The second layer 10a is, for example, a tailgate outer panel, which is welded to the inner panel. In this case, the adhesion of the trim part 1 to the roof-side portion of the body element 10 can also take place via the element 10a. In addition, the holding body 4 may abut the body element 10 via the contact wall 9 on the element 10a. Finally, it is conceivable for the body element 10 to be glued to the rear window 3 via the element 10a.

The trim assembly is fitted to the motor vehicle as follows: firstly, the holding body 4 is molded onto the upper window edge region of the rear window 3. The rear window 3 is then connected to the body element 10 by means of the adhesive bead 11, the holding body 4 coming to rest against the body element 10 via the contact wall 9. The trim element 1 is then inserted into the receiving groove 6 of the holding body 4. During insertion of the trim region 8 into the receiving groove 6, the sealing lips 8 deform elastically and ensure a secure and tight connection of the trim part 1 to the rear window 3 The rear window-side rim region 8 of the trim part 1 which is inserted into the receiving groove 6, and the receiving groove 6 itself, may have mutually complementary position elements, for example positioning grooves and positioning ribs matched thereto, so on insertion of the trim part 1 into the receiving groove 6, the Y-position thereof is clearly defined. The trim part is then pivoted about a pivot axis 13 extending along the receiving groove 6, until the trim part 1 on the roof side from above abuts the roof-side portion of the body element 10. The roof-side portion, in other words the portion remote from the rear window-side rim region 8 of the trim part 1 is finally connected to the roof-side portion of the body element 10 by means of the adhesive strip 12.

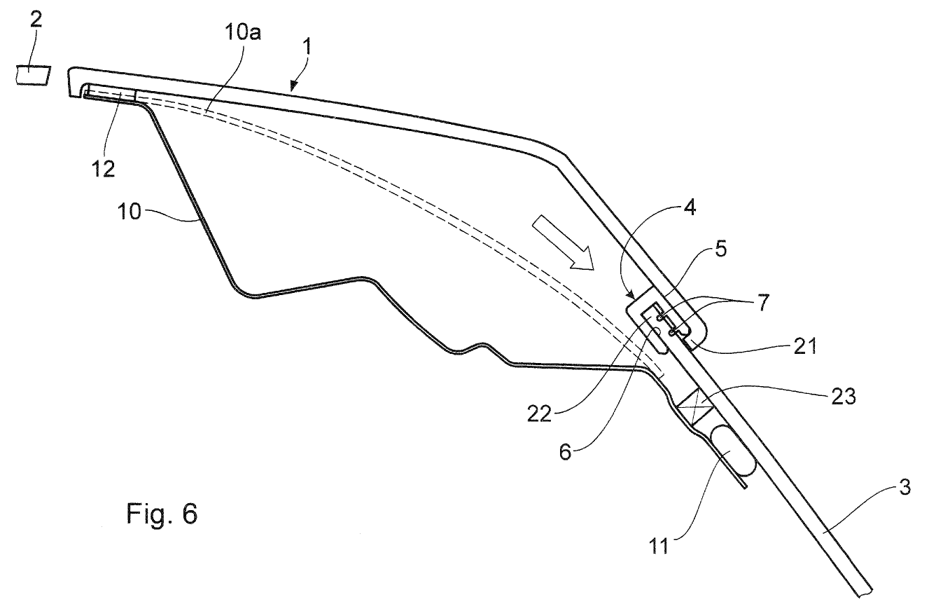

The fixing or fastening of the holding body 4 to the rear window 3 may also take place in a different manner than by molding on, for example by adhesion. The connection of the roof-side portion of the trim part 1 to the body element 10 may also take place in a different manner. A variant of the roof-side connection of the trim part 1 to the body element 10 is shown for this purpose in FIG. 4. The body element 10 is pulled upwardly on the roof side, in other words in the Z-direction and has, at its free end on the roof side, an end portion 14 bent again through 90°. The latter is used as a stop for the defined positioning of the trim part 1 relative to the roof-side portion of the body element 10. As soon as the end portion 14 rests on the inside on the roof-side portion of the trim part 1, screw openings, which are present, on the one hand, in the body element 10 and, on the other hand, in a rim region 15 of the trim part 1 pulled down inwardly by 90° toward the vehicle interior, are flush, so a screw connection 16 can be implemented there.

If the trim part 1 is loaded in the negative Z-direction, in other words downwardly, the trim part 1 is supported, on the one hand, by the holding body 4 and, on the other hand, by the adhesive strip 12 or the edge region adjacent to the roof-side portion of the body element 10, on the body element 10.

A stop corresponding to the end portion 14 may also alternatively be provided on the trim part 1.

The roof-side portion of the trim part 1 may also be clipped to the roof-side portion of the body element 10. For this purpose, the roof-side portions of the trim part 1, on the one hand, and of the body element 10, on the other hand, have mutually complementary latching portions.

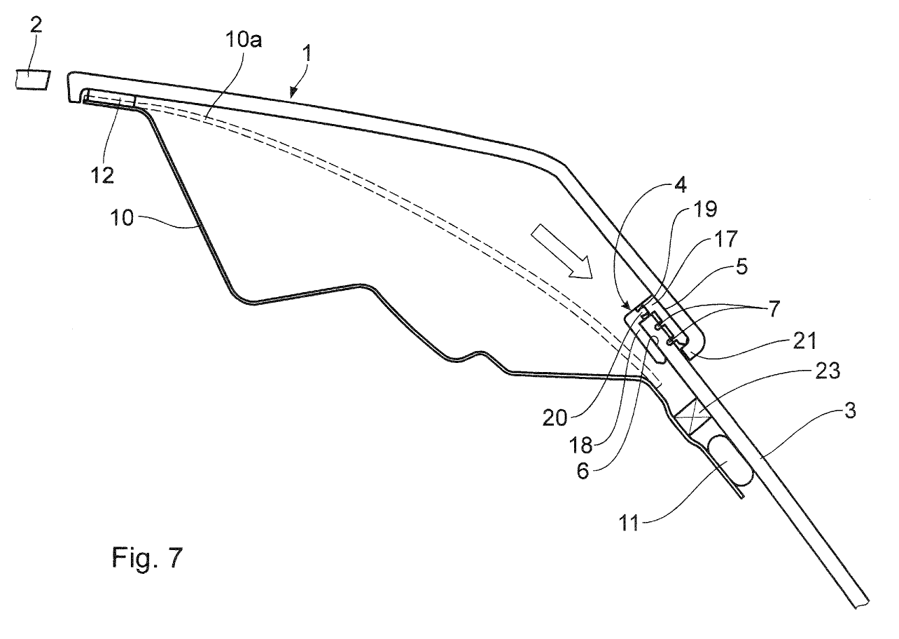

FIG. 5 shows a further embodiment of a trim assembly in a view similar to FIG. 2 including the sectional enlargement according to FIG. 3. Components corresponding to those which were already described with reference to the embodiment according to FIG. 1 to 3 have the same reference numerals and are not discussed again in detail. In the embodiment according to FIG. 5, the holding body 4 is in two parts and apart from a rear window-side first holding body part 17, which is connected to the rear window 3 in a material-uniting manner by means of the adhesion promoter layer 5, has a second holding body part 18. The two holding body parts 17, 18 are positively connected to one another by joining by means of a latching groove/tongue connection 19, 20. The first holding body part 17 in this case has the groove 19 and the second holding body part 18 has the tongue 20. The two holding body parts 17, 18 together produce precisely the spatial shape of the holding body 4 in the embodiment according to FIG. 2.

When fitting the trim assembly according to FIG. 5, before insertion of the trim part 1 into the receiving groove 6 of the holding body 4, the second holding body part 18 is joined to the first holding body part 17.

FIG. 6 shows a further embodiment of a trim assembly in a view similar to FIG. 2. Components which correspond to those which have already been described above with reference to FIG. 1 to 5 have the same reference numerals and are therefore not discussed again in detail.

In the embodiment according to FIG. 6, the holding body is not fastened in a material-uniting manner to the rear window 3, but to the trim part 1. The fastening takes place here at a lower trim edge region facing the interior of the motor vehicle adjacent to an end rim 21 of the trim part 1 angled through 90° toward the rear window 3. The rear window 3 is inserted with a trim-side rim region 22 into the receiving groove 6 of the holding body 4.

A spacer 23, which holds the rear window 3 at a spacing with respect to the body element 10 and in particular avoids the holding body 4 resting on the second layer 10a of the body element, is arranged in between the connecting region of the trim part 1 to the rear window 3 via the holding body 4 and adhesive bead 11.

The fitting process of the trim assembly according to FIG. 6 takes place analogously to that already described above with the aid of FIG. 1 to 4. The holding body 4 is fastened in the embodiment according to FIG. 6 on the trim part 1 by adhesion via the adhesion promoter layer 5. In the embodiment according to FIG. 6, the holding body 4 connected to the trim part 1, with its receiving groove 6, is placed on the edge region of the rear window 3 facing the latter. The roof-side portion of the trim part 1 with the adhesive strip 12 is then placed on the body element 10.

FIG. 7 shows a further embodiment of a trim assembly in a view similar to FIG. 6. Components which correspond to those already described above with reference to FIG. 6, have the same reference numerals and are not discussed again in detail.

In contrast to the embodiment of FIG. 6, the holding body 4 in the embodiment according to FIG. 7 is in two parts, comparably to the embodiment of the holding body 4 according to FIG. 5. The first holding body part 17 of the holding body 4 according to FIG. 7 is connected in a material-uniting manner via the adhesion promoter layer 5 to the trim part 1. The second holding body part 18 of the holding body 4 according to FIG. 7 is positively connected to the first holding body part 17 via the groove/tongue connection 19, 20 and limits therewith the receiving groove 6. Before placing the trim part 1 on the rear window 3, in the embodiment according to FIG. 7, the second holding body part 18 is joined to the first holding body part 7 via the groove/tongue connection 19, 20.

What is claimed is:

1. A motor vehicle trim assembly
with a holding body (4) having a receiving groove (6),
with a trim part (1) as part of a motor vehicle body,
wherein the holding body (4) can be fastened in a material-uniting manner to one of the group of
a motor vehicle rear window (3) in an upper window edge region facing the vehicle interior and
the trim part (1) in an upper trim part edge region facing the vehicle interior,
wherein one of the following possibilities applies:
the trim part (1) is inserted with a rear window-side rim region into the receiving groove (6);
the motor vehicle rear window (3) is inserted with a trim-side rim region into the receiving groove (6).

2. A trim assembly according to claim 1, wherein one of the following possibilities applies:
the holding body (4) can be molded onto the rear window (3);
the holding body (4) is molded onto the trim part (1).

3. A trim assembly according to claim 1, wherein the holding body (4) has a contact wall (9) for resting on a rear window-side body element (10) of the motor vehicle.

4. A trim assembly according to claim 1, wherein the trim part can be connected to a roof-side body element (10) by means of a screw connection (16), at least one of the group of trim part (1) and body element having a stop (14) for the defined positioning of the trim part (1) with respect to the roof-side body element (10).

5. A trim assembly according to claim 1, wherein the holding body (4) is produced from one of the group of a thermoplastic elastomer (TPE) and a polyurethane (PU) with a Shore hardness of 30 to 65 A.

6. A trim assembly according to claim 1, wherein the holding body (4) has at least one sealing lip (7) extending longitudinally in the receiving groove (6) for resting on at least one of the group of trim part (1) and rear window (3).

7. A trim assembly according to claim 1, wherein the holding body (4) is in two parts (17, 18), wherein
a first holding body part (17) is connected in a material-uniting manner to one of the group of motor vehicle rear window (3) and trim part (1),
a second holding body part (18), which, with the first holding body part (17), limits the receiving groove (6), is positively connected to the first holding body part (17).

8. A method for fitting a trim assembly according to claim 1 on a motor vehicle comprising the following steps:
fastening the holding body (4) on one of the group of rear window (3) and trim part (1),
connecting the rear window (3) to a rear window-side body element (10) of the motor vehicle,
inserting one of the group of trim part (1) and rear window (3) into the receiving groove (6) of the holding body (4),
pivoting the trim part (1) about a pivot axis (13) extending along the receiving groove (6) until the trim part (1) abuts a roof-side portion of the body element (10),
connecting a roof-side portion of the trim part (1) to the roof-side portion of the body element (10).

9. A method according to claim 8, wherein the holding body (4) is fastened to one of the group of rear window (3) and trim part (1) by molding the holding body (4) on one of the group of rear window (3) and trim part (1).

10. A method according to claim 8, wherein the rear window (3) is connected to the body element (10) by adhesion.

11. A method according to claim 8, wherein the roof-side portion of the trim part (1) is connected to the roof-side portion of the body element (10) by adhesion.

12. A method according to claim 8, wherein the roof-side portion of the trim part (1) is connected to the roof-side portion of the body element (10) by screwing.

13. A method according to claim 8 for fitting a trim assembly according to claim 7, wherein before joining the rear window (3) and trim part (1), the second holding body part (18) is joined to the first holding body part (17).

14. A motor vehicle assembly with a motor vehicle trim assembly according to claim 1 and a rear window (3) connected thereto.
